(19) United States
(12) Patent Application Publication
(10) Pub. No.: US 2008/0152962 A1
(43) Pub. Date: Jun. 26, 2008

(54) Controlling oxidant flow to a reactor of a fuel cell system

(76) Inventors: Vishnu L. Poonamallee, Tamilnadu (IN); John Parks, Loudonville, NY (US); Dustan L. Skidmore, Latham, NY (US); Jing Ou, Latham, NY (US); Rebecca Dinan, Rochester, NY (US); Zhi Zhou, Selkirk, NY (US)

Correspondence Address: TROP PRUNER & HU, PC, 1616 S. VOSS ROAD, SUITE 750, HOUSTON, TX, 77057-2631, US

(21) Appl. No.: 11/645,013

(22) Filed: Dec. 22, 2006

(51) Int. Cl. H01M 2/34

(52) U.S. Cl. 429/13; 429/22

(57) ABSTRACT

In a fuel cell system, a reactor oxidizes excess fuel from an exhaust of a fuel cell. Based on at least fuel flow to the reactor and a temperature associated with the reactor, a change to be made to the oxidant flow to the reactor is determined. A setting of at least one oxidant flow control element is adjusted in response to the determined change.

### BACKGROUND

This invention generally relates to controlling oxidant flow to a reactor in a fuel cell system.

A fuel cell is an electrochemical device that converts chemical energy directly into electrical energy. There are many different types of fuel cells, such as a solid oxide fuel cell (SOFC), a molten carbonate fuel cell, a phosphoric acid fuel cell, a methanol fuel cell and a proton exchange membrane (PEM) fuel cell.

As a more specific example, a PEM fuel cell includes a PEM membrane, which permits only protons to pass between an anode and a cathode of the fuel cell. At the anode of the PEM fuel cell, diatomic hydrogen (a fuel) ionizes to produce protons that pass through the PEM. The electrons produced by this reaction travel through circuitry that is external to the fuel cell to form an electrical current. At the cathode, oxygen is reduced and reacts with the protons to form water.

A typical fuel cell has a terminal voltage near one volt DC. For purposes of producing larger voltages, several fuel cells may be assembled together to form an arrangement called a fuel cell stack, an arrangement in which the fuel cells are electrically coupled together in series to form a larger DC voltage and to provide more power.

The fuel cell stack has an anode exhaust to output excess fuel (e.g., excess hydrogen or reformate). To prevent excess fuel from being exhausted into the environment, which is undesirable, a reactor, more specifically an anode tailgas oxidizer (ATO), is provided to oxidize the excess fuel. In addition, the thermal energy or heat generated from oxidizing the fuel in the ATO is used to generate steam for steam reforming for hydrogen or reformate production. To effectively oxidize the excess fuel and generate stable flow of steam with constant temperature, it is desirable to control the ATO's temperature within a predetermined range. However, the challenge associated with operation of the ATO is that it is difficult to control the proper amount of oxidant to achieve satisfactory ATO performance due to complicated ATO dynamics with long response time and strong coupling/interaction of ATO with other components (such as stack, steam circuit or reformer) in the fuel cell system.

### SUMMARY

In general, according to an embodiment of the invention, a reactor oxidizes excess fuel from an exhaust of a fuel cell. Based on at least a fuel flow to the reactor and a temperature associated with the reactor, it is determined whether a change is to be made to the oxidant flow to the reactor. A setting of at least one oxidant flow control element is then adjusted in response to the determined change.

Advantages and other features of the invention will become apparent from the following description, drawings and claims.

### BRIEF DESCRIPTION OF THE DRAWINGS

FIG. 1 is a block diagram of a portion of a fuel cell system that incorporates an embodiment of the invention.

FIG. 2 illustrates control modules used to control settings of flow control elements for controlling oxidant flow to an anode tailgas oxidizer, in accordance with an embodiment of the invention.

FIG. 3 is a flow diagram of a process of controlling the oxidant flow to the anode tailgas oxidizer, in accordance with an embodiment of the invention.

FIG. 4 is a graph that depicts correlation among fuel cell stack current, oxidant flow to the anode tailgas oxidizer, flow through a cathode air blower, and flow through a bypass valve, according to an embodiment of the invention.

### DETAILED DESCRIPTION

In accordance with some embodiments of the invention, a control mechanism is provided to control oxidant flow to a reactor to maintain a temperature of the reactor within a predetermined desired temperature range. The reactor is used to oxidize excess fuel that is output from the exhaust of a fuel cell stack. In some embodiments, the reactor is referred to as an anode tailgas oxidizer (ATO). The control mechanism controls flow control elements, in the form of a cathode air blower and a bypass valve, for example, to control the oxidant flow to the reactor. In one implementation, the oxidant provided to the reactor is air. In other embodiments, other types of oxidants can be used.

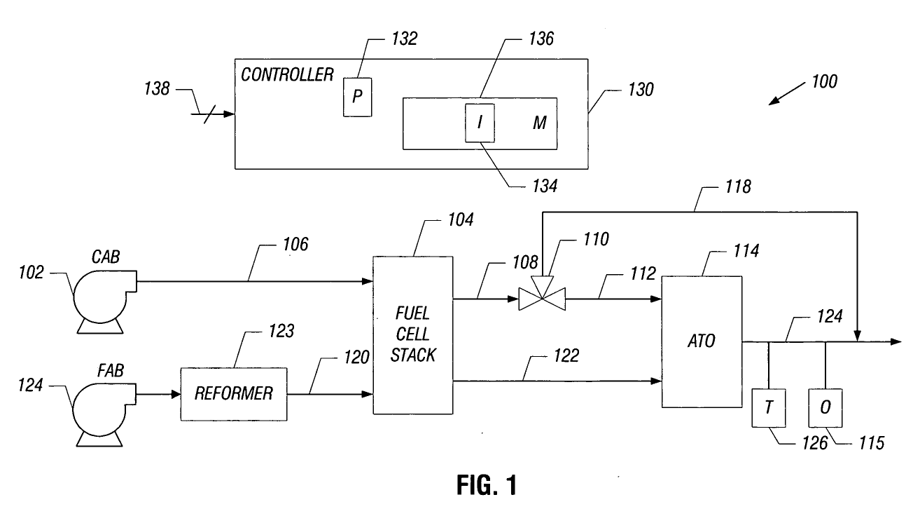

FIG. 1 is a general block diagram of portions of a fuel cell system 100. The fuel cell system 100 has a cathode air (and/or oxidant) blower 102 to furnish an air flow at its outlet to a fuel cell stack 104 (that contains fuel cells). Note that additional components may be provided between the cathode air blower 102 and the fuel cell stack 104, with these components omitted for the sake of clarity. The air (which is a type of oxidant) from the cathode air blower 102 is provided to the cathode inlet 106 of the fuel cell stack 104. The incoming oxidant flow received at the cathode inlet 106 passes through a cathode chamber of the fuel cell stack 104, which represents the flow passageways through the cathodes of the fuel cells of the fuel cell stack 104. The oxidant flow into the cathode inlet produces a corresponding cathode exhaust, which exits the fuel cell stack 104 at a cathode outlet 108.

The cathode exhaust 108 passes through a three-way valve 110 (referred to as a bypass valve). The three-way valve 110 has a first outlet 112 to produce oxidant flow to an ATO 114. The bypass valve 110 has a second outlet to allow oxidant flow from the cathode outlet 108 of the fuel cell stack 104 to bypass the ATO 114 along path 118.

The fuel cell stack 104 also includes an anode inlet 120 that receives a fuel (e.g., hydrogen or hydrogen rich reformate) from a fuel source such as a reformer 123. The reformer 123 receives a mixture of a source fuel (e.g., hydrocarbons) and air from a source fuel/air blower 124. The source fuel/air blower 124 provides a flow of source fuel and air to the reformer 123. The reformer 123 performs processing to convert the source fuel (e.g., hydrocarbons) into fuel (e.g., hydrogen or hydrogen rich reformate) for the fuel cell stack 104. The fuel received at the anode inlet 120 is communicated through an anode chamber of the fuel cell stack 104 for the purpose of sustaining the electrochemical reactions inside the fuel cell stack 104. The fuel flow through the fuel cell stack 104 produces a corresponding anode exhaust, which exits the fuel cell stack 104 at an anode exhaust outlet 122. The anode exhaust from the fuel cell stack 104 is provided to an input of the ATO 114, where the ATO 114 can oxidize the excess fuel that is output from the anode exhaust 122 of the fuel cell stack 104.

As a result of the oxidation inside the ATO 114, a relatively emission-free exhaust flow is produced by the fuel cell system 100, which exits the ATO 114 at ATO outlet 124.

As depicted in FIG. 1, a temperature sensor 126 is provided to measure a temperature at the exhaust (outlet) 124 of the ATO 114. Alternatively, in a different implementation, the temperature sensor 126 can be provided inside the ATO 114, such as at a catalyst of the ATO 114.

The components of the fuel cell system 100 are controlled by a controller 130. The control tasks that can be performed by the controller 130 include the control of settings of the cathode air blower 102 and the bypass valve 110. In general, the controller 130 can take on numerous forms, depending on a particular embodiment. In general, the controller 130 includes a processor 132, which may be formed from one or more microprocessors, microcontrollers, computers, or a combination of these components. In general, the processor 132 executes program instructions 134, which are stored in a memory 136. The memory 136 can be built into the controller 130 or can be external to the controller 130. The program instructions 134, when executed by the processor 132, cause the controller 130 to perform one or more control tasks with respect to the fuel cell system 100.

The controller 130 includes various input communication lines 138 to receive communications from other controllers, readings from sensors, current and voltage measurements (such as current measurements of fuel cells in the fuel cell stack 104), and so forth. Through the communication lines 138, the controller 130 is able to observe various states, operating conditions, and measurements of the fuel cell system 100. Based on these measured parameters and communications, the controller 130 can perform control functions or tasks.

The arrangement of FIG. 1 is provided for purposes of illustration. In other implementations, other arrangements of the fuel cell system can be used.

To ensure proper operation of the ATO 114, it is desirable to maintain the temperature of the ATO 114 within a desired range to ensure complete or increased oxidation of the excess fuel output from the fuel cell stack 104. Ideally, the target ATO temperature is as high as possible, close to the equilibrium point where all the oxidant is used up in the oxidation reactions and thus no extra oxidant is left. In reality, due to uncertainties, such as flow distribution and catalyst activity in the ATO 114, some extra amount of oxidant is required to guarantee enough oxidant for the oxidation reactions in the ATO. The extra oxidant can lead to reduced ATO temperature.

To achieve proper control of oxidant flow to the ATO 114, the controller 130 controls settings of the cathode air blower 102 and the bypass valve 110 based on various input factors. Note that the hydrogen (or other fuel) flow to the ATO 114 is continually varied and is set by fuel cell current and efficiency control.

The cathode air blower 102 serves a dual purpose of providing oxidant to both the fuel cell stack 104 and the ATO 114. The cathode air blower 102 supplies oxidant to the cathode inlet 106 of the fuel cell stack 104, with a depleted exhaust stream of oxidant provided from the cathode outlet 108 of the fuel cell stack 104 to the ATO. The ATO bypass valve 110 positioned right after the cathode exhaust outlet 108 is used to divert excess air in order to maintain the ATO temperature.

The controller 130 provides a control mechanism that controls the ATO temperature based on the oxidant flow and the hydrogen flow to the ATO 114. The required settings of the oxidant flow control elements, including the cathode air blower 102 and bypass valve 110, as examples, are then calculated by the controller 130.

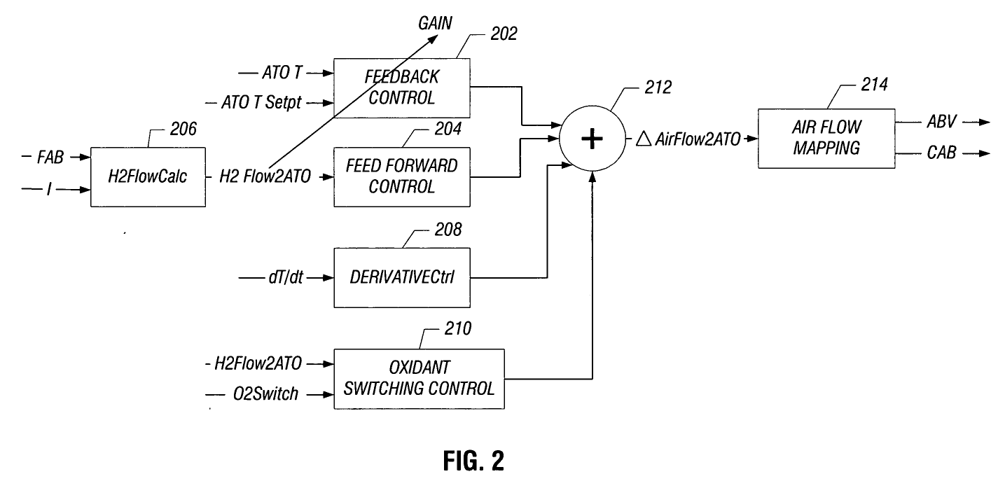

The control modules used by the controller 130 to provide settings for the cathode air blower 102 and the bypass valve 110 are depicted in FIG. 2. The control modules of FIG. 2 include a feedback control module 202 and a feedforward control module 204. The feedback control module 202, which can be implemented as a model predictive controller (MPC) or a proportional integral and derivative (PID) controller, considers feedback from the ATO 114. In this regard, the feedback control module 202 generates a control input based on a difference between the ATO temperature (ATO T), which is measured by the temperature sensor 126 of FIG. 1, at the exhaust of the ATO 114, and a predetermined set point (ATO T Setpt), or threshold temperature. The difference between the ATO temperature (ATO T) and the threshold (ATO T Setpt) is an error value. The feedback control module 202 regulates oxidant flow based on the error value for purposes of regulating the temperature of the ATO to a desired level.

The feedforward control module 204 receives an estimated hydrogen flow (H2Flow2ATO) to the ATO 114. The value H2Flow2ATO is an estimated value (rather than a measured value) that is calculated by a hydrogen flow calculator 206, which receives as input the setting of the source fuel/air blower 124 (FAB) and the measured current (I) of the fuel cell stack 104. Based on FAB and I, the hydrogen flow calculator 206 computes the value of H2Flow2ATO, which is provided to the feedforward control module 204.

Two other modules depicted in FIG. 2 include a derivative control module 208 and an oxidant switching control module 210 (discussed further below).

The outputs of the control modules 202, 204, 208, and 210 are provided to a summer or adder 212, which sums the output signals from the modules 202, 204, 208, and 210. The summer 212 then outputs a parameter ΔAirFlow2ATO, which represents the change in air flow required to the ATO 114. An air flow mapping module 214 is used to map a required air flow to the ATO (which takes into account the ΔAirFlow2ATO parameter) to an ABV parameter (which represents the desired air flow through the bypass valve 110), and CAB parameter (which represents the air flow through the cathode air blower 102). The ABV and CAB parameters, which represent flow values, can be translated to a setting for the cathode air blower 102 or the bypass valve 110. For example, a first mapping data structure can be used to correlate CAB values to settings for the cathode air blower 102, and a second mapping data structure can be used to map ABV values to settings for the bypass valve 110.

More generally, the cathode air blower and bypass valve are considered flow control elements. Generally, a “setting” of a flow control element can refer to either an actuation position of the flow control element (on, off, incremental position 1, etc.) or to a fluid flow indication (e.g., flow rate) of the flow control element.

Constraints can be set for the controller 130 regarding air flow to the ATO 114. One constraint is a maximum ATO air flow, which corresponds to a predefined maximum setting at the cathode air blower (which maximum setting can be expressed as a voltage or by some control input) and a predefined minimum setting at the bypass valve 110 (which can also be expressed as a voltage or by some other control input). In other words, maximum air flow to the ATO 114 occurs when the cathode air blower 102 is operating at the predefined maximum setting, and the bypass valve 110 is operating at the predefined minimum setting. Another constraint is the minimum ATO air flow, which is defined by the maximum of the following flows: (1) the air flow obtained from a predefined minimum setting for the cathode air blower 102 specified by the fuel cell stack's requirement of two cathode stoics, and a predefined maximum setting for the bypass valve 110; and (2) the minimum ATO air flow necessary to maintain ATO fuel-lean operation.

Fuel-lean operation refers to a condition of the ATO 114 in which excessive fuel (e.g., hydrogen or hydrogen rich reformate) is not exhausted from the ATO 114. A fuel-lean condition is contrasted with a fuel-rich condition, in which excess fuel is present at the ATO. In one implementation, a percentage of oxidant content less than some predefined threshold (e.g., less than 1,000 ppm in the exhaust gas from the ATO) is indicative of a fuel-rich condition of the ATO 114.

The gain used by the feedback control module 202 is adjustable based on the fuel flow to the ATO 114 (represented by H2Flow2ATO). The ATO temperature (represented by ATO T) depends on H2Flow2ATO; in other words, the ATO temperature is more sensitive to the air flow to the ATO at lower fuel flow rates than at higher fuel flow rates, indicating that the control parameters should be adapted according to H2Flow2ATO. The gain of the feedback control module 202 can either be adapted online using adaptive control principles, or can be obtained offline by doing step tests at different fuel flows to the ATO 114.

If the feedback controller 202 is implemented with an MPC (model predictive controller), then the derivative control module 208 is utilized. Note that if the feedback controller 202 is implemented with a PID (proportional integral and derivative controller), then the derivative control module 208 is not employed. An MPC controller lacks a direct rate check capability in its structure. The derivative control module 208 is needed when an MPC controller is used especially during startup of the fuel cell system since it has been observed in some cases that the ATO temperature will increase at a rapid rate beyond a predefined limit (e.g., a safe operating region boundary) that can cause system shutdown. The input to the derivative control module 208 is a term represented as dT/dt, which is the derivative of the difference between the ATO temperature, represented by ATO T, and the ATO set point, represented as ATO Setpt, with respect to time. The derivative action performed by the derivative control module 208 is proportional to a first order derivative of the error (difference between the ATO temperature and the ATO set point) with respect to time.

The oxidant switching control module 210 receives the following inputs: the estimated fuel flow to the ATO, represented by H2Flow2ATO; and an output (represented as O2Switch) from a sensor 115 (see FIG. 1) that detects oxidant content in the exhaust gas from the ATO 114. The oxidant switching control module 210 continually determines (based on the output of the oxidant sensor 115) whether the ATO 114 is operating in a fuel-lean condition (a normal condition) or a fuel-rich condition (in which the oxidant content falls below some predefined threshold, e.g. 1000 ppm). Upon detecting a fuel-rich condition in the ATO 114, the oxidant switching control module 210 performs the following corrective actions: (1) disable the feedback control module 202 such that the feedback control module 202 does not attempt to increase oxidant flow in response to detecting increasing temperature (note that in the fuel-rich condition, increasing oxidant flow to the ATO will lead to increased temperature rather than decreased temperature as would occur during the fuel-lean condition); and (2) an oxidant flow is increased by a factor proportional to the amount of fuel flow going to the ATO 114, represented by H2Flow2ATO, with the amount of oxidant flow increased until the ATO 114 transitions back to the fuel-lean condition.

Once the ATO 114 transitions back from the fuel-rich condition to the fuel-lean condition, the feedback control module 202 is re-enabled by the oxidant switching control module 210. The output of the oxidant switching control module 210 is provided as one of the inputs to the summer 212 for computing the value of ΔAirFlow2ATO.

The calculation performed by the H2Flow2ATO calculation module 206 (which calculates a value of H2Flow2ATO from the FAB and I inputs, which represent a setting of the source fuel/air blower 124 and the fuel cell stack current, respectively). H2Flow2ATO is calculated by one of the following:

$$\begin{matrix}\begin{matrix}H 2 Flow 2 ATO = ano \cdot H 2 \\ = ani \cdot H 2 - stk \cdot H 2 \\ = H 2 Stoic * stk \cdot H 2 - stk \cdot H 2 \\ = ( H 2 Stoic - 1 ) * stk \cdot H 2 \\ = ( H 2 Stoic - 1 ) * ( 0.007 * I * Cells ) [ slm ]\end{matrix} \\ or & ( Eq . 1 ) \\ \begin{matrix}H 2 Flow 2 ATO = ano \cdot H 2 \\ = ani \cdot H 2 - stk \cdot H 2 \\ = ani \cdot H 2 - 0.007 * I * Cells [ slm ]\end{matrix} & ( Eq . 2 )\end{matrix}$$

In the equations above, the value ano.H2 represents the hydrogen provided from the anode outlet of the fuel cell stack 104. The parameter ani.H2 represents the hydrogen flow to the anode inlet of the fuel cell stack 104, while stk.H2 represents the hydrogen consumed by the fuel cell stack. The parameter H2Stoic represents the stoichiometry of the hydrogen, which is the ratio of the amount of hydrogen supplied to the fuel cell stack to the amount of hydrogen consumed by the fuel cell stack. The parameter I represents the current of the fuel cell stack, and the parameter Cells represents the number of fuel cells in the fuel cell stack. Thus, it can be seen from Eq. 1 that the value of H2Flow2ATO is calculated from the H2 stoichiometry, the fuel cell stack current, and the number of fuel cells.

Alternatively, in Eq. 2, the value of H2Flow2ATO is computed based on the hydrogen flow to the anode inlet of the fuel cell stack, the fuel cell stack current, and the number of fuel cells in the fuel cell stack.

The air flow mapping performed by the air flow mapping module 214 is described below. Eq. 3 below is the equation for calculating air flow to the ATO (represented as ATOFlow), where atoi represents the air flow to the inlet of the ATO, cao represents the air flow from the cathode outlet of the fuel cell stack, bypassfrac represents the flow fraction that bypasses the ATO (which corresponds to the setting of the bypass valve 110), cai represents the air flow to the cathode inlet of the fuel cell stack, stk.O2 represents the amount of oxidant consumed by the fuel cell stack, f1(CAB, ABV) represents a first function that is dependent upon the flow values CAB and ABV for the cathode air blower and bypass valve, respectively, f2(ABV, CAB) is a second function that is dependent upon the values ABV and CAB, and f(CAB, ABV, I) is a function that is dependent upon the CAB, ABV, and I values. From Eq. 3 below, it is observed that a function (f(CAB, ABV, I)) is derived to map CAB, ABV, and I values to air flow to ATO.

$$\begin{matrix}AirFlow 2 ATO = atoi \\ = cao * ( 1 - bypassfrac ) \\ = ( cai - stk , O 2 ) * ( 1 - byassfrac ) \\ = ( cai - 0.0035 * I * Cells ) * \\ ( 1 - bypassfrac ) [ slm ] \\ = ( f 1 ( CAB , aBV ) - 0.0035 * I * Cells ) * \\ ( 1 - f 2 ( ABV , CAB ) ) \\ = f ( CAB , ABV , I )\end{matrix} \qquad ( Eq . 3 )$$

The function f1(CAB, ABV) represents a first characterization of the cathode air flow, whereas the function f2(ABV, CAB) represents the bypass fraction controlled by the setting of the bypass valve 110.

The following describes the procedure performed by the controller 130 in accordance with an embodiment of the invention. The current (present) air flow to the ATO is represented by the function f(CAB, ABV, I). The required air flow is equal to the current air flow plus the flow change produced by the controller 130, which is ΔAirFlow2ATO produced by the summer 212.

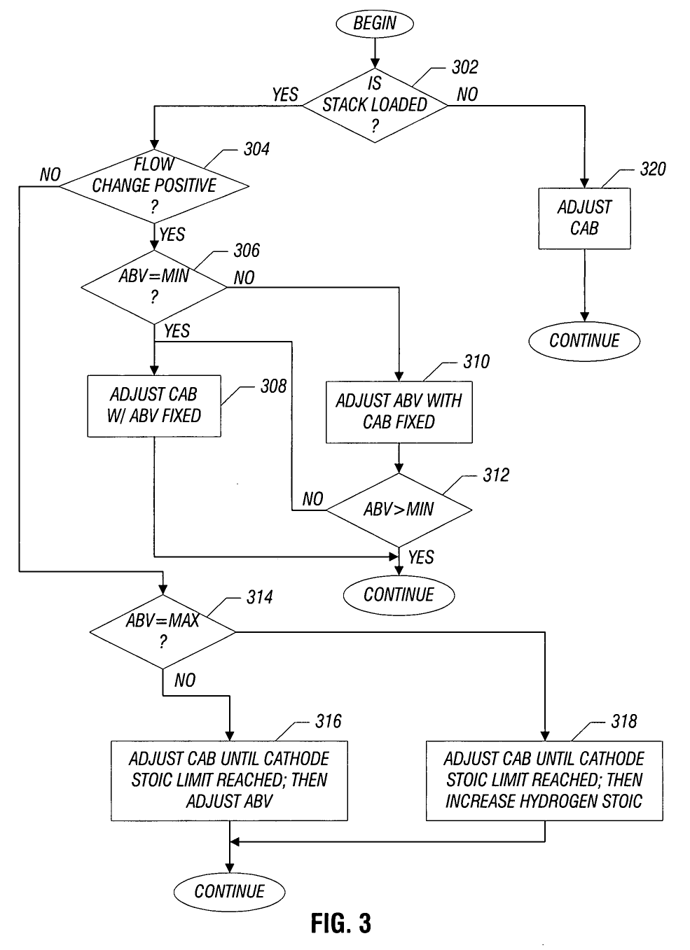

As depicted by FIG. 3, the controller 130 checks (at 302) whether the fuel cell stack 104 is loaded (in other words, whether the fuel cell stack is running). If the fuel cell stack 104 is loaded, then the controller 130 checks (at 304) whether the flow change of the air flow is positive (in other words, ΔAirFlow2ATO is positive; that is, more air flow to the ATO should be added). If so, the controller 130 checks (at 306) whether ABV is at a minimum value (which corresponds to a minimum setting of the bypass valve 110). Since the ABV is at a minimum value (which indicates that minimum or no bypass of air is occurring around the ATO 114 by the bypass valve 110), then only the cathode air blower 102 is adjusted by adjusting the CAB value (at 306). The CAB value is derived (at 308) from the following relationship: ATOFlow=f(CAB, ABV, I), where ATOFlow represents the required flow. In the equation above, ABV is a known minimum value, and I is the known current load for the fuel cell stack. Thus, CAB is the only unknown. If the function f(CAB, ABV, I) is a linear equation, then the value for CAB can be readily derived by solving the linear equation.

On the other hand, if ABV is not at its minimum, as determined at 306, then the ABV value is adjusted (at 310) while the CAB value remains fixed. Adjusting ABV is achieved by solving the linear equation for ATOFlow=f(CAB, ABV, I), in which CAB and I are known values and ABV is the unknown value. After solving for ABV, the controller checks (at 312) if the ABV value is greater than the predefined minimum; if so, then the required flow is achievable with just adjusting just the ABV. If the adjusted value of ABV is less than the predefined minimum, then the ABV value set at 310 is below the predefined minimum, in which case, CAB would have to be adjusted to achieve the required air flow (performed at 306).

If, on the other hand, it is determined (at 304) that the flow change is negative (ΔAirFlow2ATO is negative to indicate a drop in air flow is needed), then the following is performed. First, the controller 130 checks (at 314) whether the ABV is at a predefined maximum. If not, that is an indication that it is possible to adjust ABV to reduce air flow to the ATO. In this case, the CAB is first changed (at 316) until the cathode (air) stoichiometry is ≦2 (the ratio of air supplied to the fuel cell stack to the air consumed by the fuel cell stack is less than or equal to two), at which time adjustment of ABV is performed. Adjustment of CAB is performed by solving for the linear equation ATOFlow=f(CAB, ABV, I). If the cathode stoichiometry limit is reached and ABV has to be adjusted, the linear equation is similarly solved to find ABV.

If it is determined (at 314) that ABV is at its maximum value (indicating that no further adjustment of ABV is possible to bypass air flow from the ATO), then the CAB value is changed (at 318) by solving the linear equation ATOFlow=f(CAB, ABV, I), until a cathode stoic limit reached, after which the hydrogen stoic is increased.

If the stack is not loaded, as determined at 302, then that is an indication that the system is running with the reformer only. In this case, only the cathode air blower is changed (at 320) to obtain the required flow, with the bypass valve setting remaining unchanged.

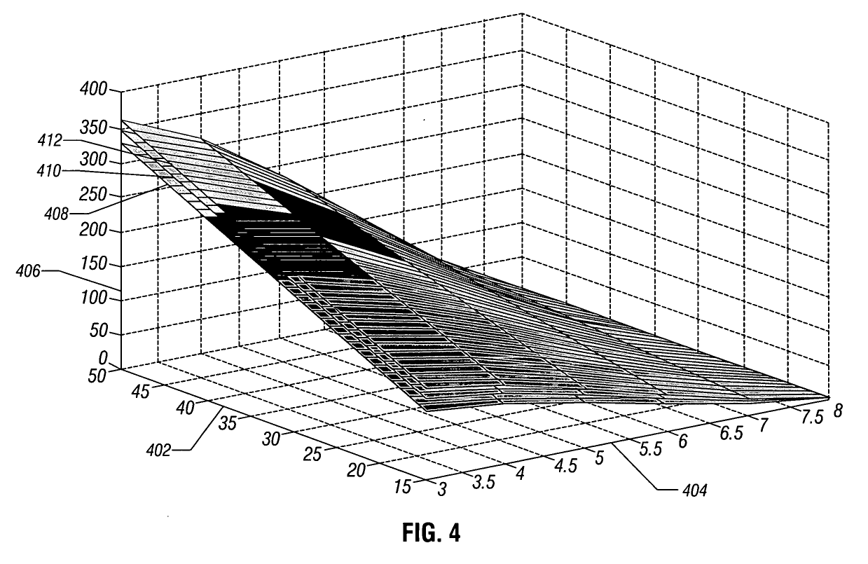

The above discussion assumes that a linear relationship exists between ATOFlow and the CAB, ABV, and I values. If the linear relationship does not exist, then a map is defined to correlate ATOFlow to the CAB, ABV, and I values (which may have a non-linear relationship). An example of such a map is depicted in FIG. 4, which illustrates three curved surfaces corresponding to three different I values. Note that additional surfaces could exist for additional I values. An axis 402 represents the CAB values, an axis 404 represents ABV values, and an axis 406 represents ATOFlow values.

In this case, if ABV has to be adjusted for a fixed CAB, then for a given current I, a curve on a corresponding one of the surfaces 408, 410, and 412 is identified. Then the controller finds a point on the curve that corresponds to the required ATOFlow value to identify the ABV value.

A similar technique is performed for finding CAB for a fixed ABV and a known I value to find the point on a curve corresponding to the required ATOFlow value.

Instructions of software described above (including instructions 134 of FIG. 1) are loaded for execution on a processor (e.g., 132 in FIG. 1). As used here, a “controller” refers to hardware, software, or a combination thereof. A “controller” can refer to a single component or to plural components (whether software or hardware).

Data and instructions (of the software) are stored in respective storage devices, which are implemented as one or more computer-readable or computer-usable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs).

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A method for use in a fuel cell system, comprising:
oxidizing, by a reactor, excess fuel from an exhaust of a fuel cell;
determining, based on at least fuel flow to the reactor and a temperature associated with the reactor, a change to be made to the oxidant flow to the reactor; and
adjusting a setting of at least one oxidant flow control element in response to the determined change.

2. The method of claim 1, wherein adjusting the setting of the at least one oxidant flow control element comprises adjusting the setting of an oxidant and/or air blower.

3. The method of claim 2, wherein adjusting the setting of the at least one oxidant flow control element further comprises adjusting the setting of a bypass valve that is coupled to the reactor to bypass oxidant around the reactor.

4. The method of claim 3, further comprising the bypass valve receiving oxidant flow from an oxidant exhaust of the fuel cell.

5. The method of claim 1, further comprising estimating the fuel flow, wherein determining the change to be made to the oxidant flow is based on at least the estimated fuel flow and the temperature associated with the reactor.

6. The method of claim 5, wherein estimating the fuel flow is based on a setting of a source fuel and air blower and a current of the fuel cell.

7. The method of claim 1, wherein oxidizing the excess fuel from the exhaust of the fuel cell comprises oxidizing the excess fuel from the exhaust of a fuel cell stack containing plural fuel cells.

8. The method of claim 1, wherein adjusting the setting of the at least one flow control element comprises solving a linear equation that maps oxidant flow to the setting of the at least one flow control element and at least one other parameter.

9. The method of claim 8, wherein the at least one other parameter comprises a current of the fuel cell.

10. The method of claim 1, wherein adjusting the setting of the at least one flow control element comprises accessing a non-linear map that correlates settings of the at least one flow control element to the oxidant flow and at least one other parameter.

11. The method of claim 1, wherein determining the change to be made to the oxidant flow is based on output of a feedback control module that determines a difference between a temperature of the reactor and a threshold temperature.

12. The method of claim 12, wherein determining the change to be made to the oxidant flow is further based on output of a feedforward control module that receives as input the fuel flow to the reactor.

13. The method of claim 12, wherein determining the change to be made to the oxidant flow further comprises an adder summing outputs of the feedback control module and the feedforward control module.

14. A fuel cell system comprising:
a fuel cell that has a fuel exhaust;
a reactor to oxidize the fuel exhaust from the fuel cell; and
a controller to:
control oxidant flow to the reactor based at least on estimated fuel flow to the reactor and a temperature of the reactor.

15. The fuel cell system of claim 14, wherein the reactor comprises an anode tailgas oxidizer.

16. The fuel cell system of claim 14, further comprising at least one flow control element to control flow of oxidant to the reactor, wherein the controller controls the at least one flow control element to control the oxidant flow to the reactor.

17. The fuel cell system of claim 16, wherein the at least one flow control element comprises an oxidant blower to supply oxidant to the fuel cell.

18. The fuel cell system of claim 16, further comprising a bypass valve coupled between an oxidant exhaust of the fuel cell and an oxidant inlet to the reactor, the controller to further control the bypass valve to control oxidant flow to the reactor.

19. An apparatus for use in a fuel cell system having a fuel cell and reactor for oxidizing excess fuel exhausted from the fuel cell, comprising:
a controller to:
receive indications of a temperature of the reactor and fuel flow to the reactor, and
based at least on the indications of the temperature and the fuel flow, control at least one flow control element to control oxidant flow to the reactor.

20. The apparatus of claim 19, wherein the controller is configured to further:
determine a change to be made to the oxidant flow to the reactor based at least on the indications o the temperature and the fuel flow, and
map the change to a setting of the at least one flow control element.

21. The apparatus of claim 20, wherein the mapping is based on a linear equation correlating oxidant flow to the reactor to the setting of the at least one flow control element.

22. The apparatus of claim 20, wherein the mapping is based on a non-linear relationship between the oxidant flow to the reactor and the setting of the at least one flow control element.
